(19) United States
(12) Patent Application Publication
(10) Pub. No.: US 2019/0047819 A1
(43) Pub. Date: Feb. 14, 2019

(54) ELEVATOR SAFETY AND CONTROL SYSTEMS

(71) Applicant: Otis Elevator Company, Farmington, CT (US)

(72) Inventors: Eric Vaunois, Briare (FR); Bruno Quaretti, Nevoy (FR)

(21) Appl. No.: 16/051,760

(22) Filed: Aug. 1, 2018

(30) Foreign Application Priority Data
Aug. 14, 2017 (EP) 17306066.6

(51) Int. Cl. B66B 5/16; B66B 5/00; B66B 3/00

(52) U.S. Cl. CPC B66B 5/16; B66B 3/002; B66B 5/0012

(57) ABSTRACT

Elevator safety and control systems including an elevator car moveable within an elevator shaft, at least one operational state element associated with movement of the elevator car within the elevator shaft, a passenger sensor positioned within the elevator car and configured to monitor an occupancy area of interest inside the elevator car and to observe at least one passenger located in the occupancy area of interest, and an elevator control module in communication with the passenger sensor and the at least one operational state element. The elevator control module is configured to determine an emergency state of operation of the elevator car, determine a presence of at least one passenger within elevator car, and perform emergency response action.

### BACKGROUND

The subject matter disclosed herein generally relates to elevator systems and, more particularly, to elevator safety and control systems.

Conventional elevator systems include cameras that monitor the presence of passengers in an elevator car. However, traditional sensing technologies are typically limited to detecting passenger boarding/deboarding and elevator car occupancy. Traditional elevator operation, however, is not controlled according to the behavior of one or more passengers.

During operation of the elevator, emergency events, unauthorized actions by passengers, etc. may occur which require security and/or emergency personnel to be alerted. Conventional elevator emergency systems, however, require that security staff manually monitor video feeds to detect emergency events and/or rely upon actions of the passengers within the elevator (e.g., manual operation of an emergency call button). Moreover, once an emergency event is detected, the responding personnel must manually intervene by locating the elevator car during ride operation or within the elevator shaft and/or manually disable the elevator car from service. The conventional means for responding to emergency events is therefore time-consuming and inefficient.

### SUMMARY

According to some embodiments, elevator safety and control systems are provided. The elevator safety and control systems include an elevator car moveable within an elevator shaft, at least one operational state element associated with movement of the elevator car within the elevator shaft, a passenger sensor positioned within the elevator car and configured to monitor an occupancy area of interest inside the elevator car and to observe at least one passenger located in the occupancy area of interest, and an elevator control module in communication with the passenger sensor and the at least one operational state element. The elevator control module is configured to determine an emergency state of operation of the elevator car, determine a presence of at least one passenger within elevator car, and perform emergency response action.

In addition to one or more of the features described above, or as an alternative, further embodiments of the elevator safety and control systems may include that the at least one operational state element is one or more of a safety gear, an emergency brake, an acceleration/deceleration sensor, and a safety chain.

In addition to one or more of the features described above, or as an alternative, further embodiments of the elevator safety and control systems may include that the passenger sensor is a motion tracking sensor.

In addition to one or more of the features described above, or as an alternative, further embodiments of the elevator safety and control systems may include that the elevator control module is further configured to initiate a timer at the time of determining an emergency state of operation and the presence of the at least one passenger within the elevator car.

In addition to one or more of the features described above, or as an alternative, further embodiments of the elevator safety and control systems may include that, upon expiration of the timer, the emergency response action is performed.

In addition to one or more of the features described above, or as an alternative, further embodiments of the elevator safety and control systems may include that the emergency response action is at least one of notification of emergency personnel or services, making an automated phone call or electronic request to emergency services, alerting security/emergency personnel, cancelling an elevator call, generating an acoustic alert, or overriding a current elevator operational state.

According to some embodiments, methods for performing elevator safety and control operations are provided. The methods include determining, with an elevator control module, an emergency state of operation of an elevator car within an elevator shaft, determining a presence of at least one passenger within the elevator car, and performing an emergency response action upon determination of the emergency state of operation and the presence of the at least one passenger within the elevator car.

In addition to one or more of the features described above, or as an alternative, further embodiments of the methods may include that the elevator control module is in communication with at least one operational state element associated with movement of the elevator car within the elevator shaft, the method further including receiving operational state information at the elevator control module from the at least one operational state element.

In addition to one or more of the features described above, or as an alternative, further embodiments of the methods may include that the at least one operational state element is one or more of a safety gear, an emergency brake, an acceleration/deceleration sensor, and a safety chain.

In addition to one or more of the features described above, or as an alternative, further embodiments of the methods may include that the elevator control module is in communication with a passenger sensor positioned within the elevator car and configured to monitor an occupancy area of interest inside the elevator car and to observe at least one passenger located in the occupancy area of interest. The method further includes receiving information associated with a detected passenger at the elevator control module from the passenger sensor.

In addition to one or more of the features described above, or as an alternative, further embodiments of the methods may include that the emergency response action is at least one of notification of emergency personnel or services, making an automated phone call or electronic request to emergency services, alerting security/emergency personnel, cancelling an elevator call, generating an acoustic alert, or overriding a current elevator operational state.

In addition to one or more of the features described above, or as an alternative, further embodiments of the methods may include initiating a timer at the time of determining an emergency state of operation and the presence of the at least one passenger within the elevator car.

In addition to one or more of the features described above, or as an alternative, further embodiments of the methods may include that, upon expiration of the timer, the emergency response action is performed.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of an elevator safety and control system according to a non-limiting embodiment; and

FIG. 3 is a flow process in accordance with an embodiment of the present disclosure.

### DETAILED DESCRIPTION

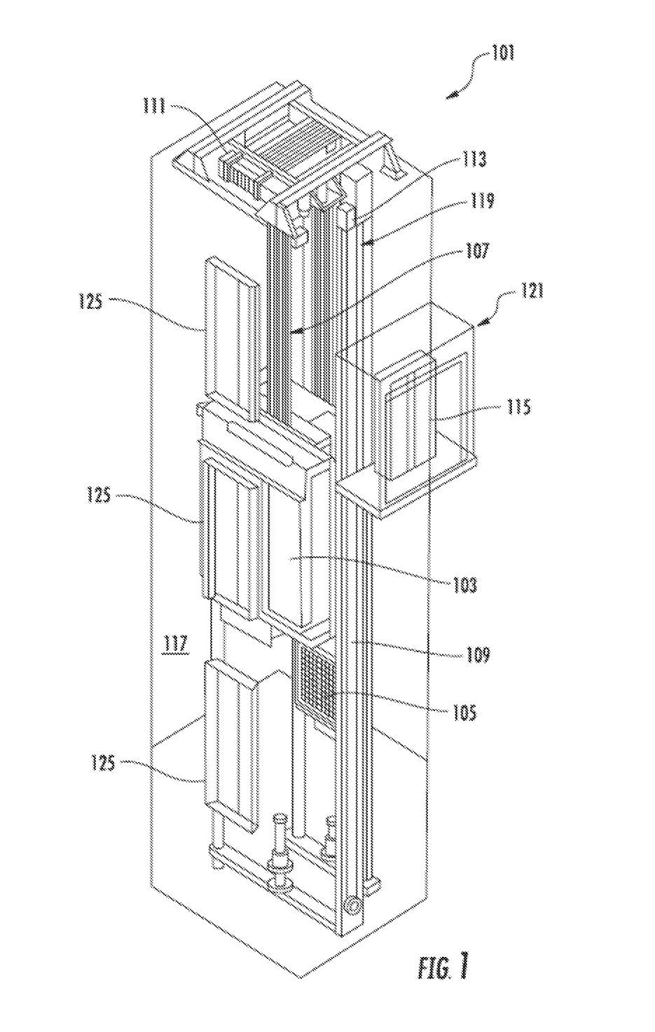

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which, in this illustrative embodiment, is part of an overhead structure of the elevator system 101, although other arrangements are possible without departing from the scope of the present disclosure. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown in the illustrative arrangement, in a controller room 121 of the elevator shaft 117 and is configured to control the operation of the elevator system 101, and particularly the elevator car 103. In other embodiments the controller 115 can be located in other locations, including, but not limited to, fixed to a landing or landing door or located in a cabinet at a landing. The elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

Various non-limiting embodiments of the present disclosure utilize motion tracking sensors such as, for example, video, radar, infrared, etc., to detect movements of one or more passengers in addition to monitoring an operational state of an elevator. An electronic elevator control module can be programmed with software, anatomical models, and/or motion algorithms that distinguish normal movements from abnormal movements and may determine that one or more security/emergency actions are necessary based on the abnormal movements. The security/emergency actions include, but are not limited to, alerting security/emergency personnel, cancelling an elevator call in order not to put passengers in an enclosed/unmonitored space for their safety and the safety of passengers standing by, generating an acoustic alert to notify the passenger(s) of a security issue, and/or automatically overriding current elevator operations. An elevator car over-ride can include, for example, returning the elevator car directly to the lobby or removing the elevator car from service by stopping at a next available floor or specific floor, and/or controlling operation of the elevator doors until the security/emergency event is resolved. In this manner, alerted security/emergency personnel can conveniently and quickly intervene and/or intercept one or more suspect passengers.

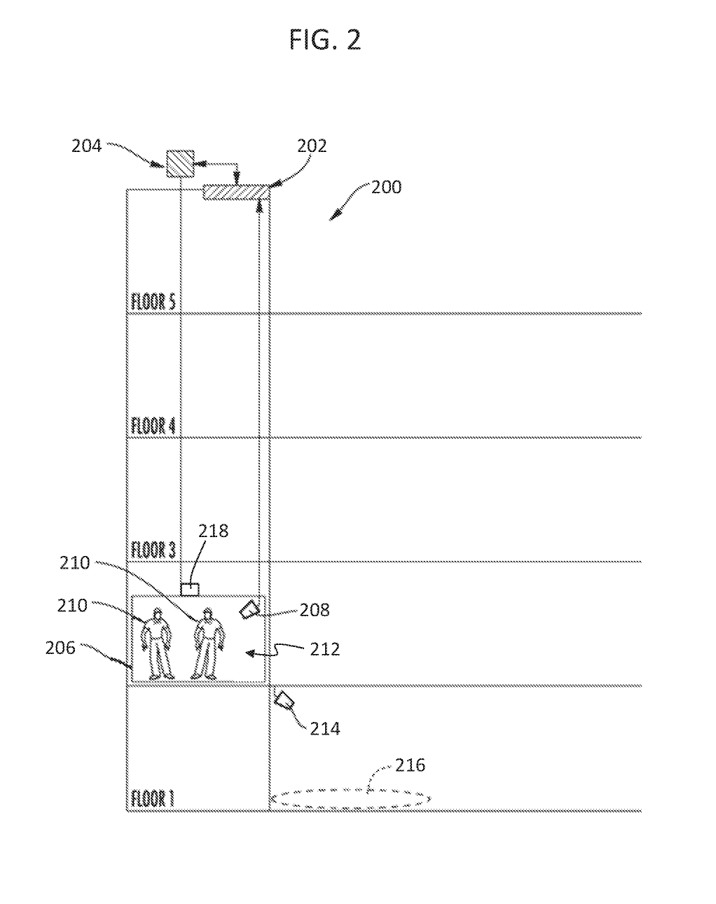

Referring now to FIG. 2, a schematic illustration of an elevator safety and control system 200 is shown. The elevator safety and control system 200 includes an electronic elevator control module 202 and an elevator car driving assembly 204. The elevator car driving assembly 204 includes a machine that imparts movement to an elevator car 206 as described above and as readily understood by those of skill in the art. The elevator control module 202 includes an electronic microcontroller, for example, configured to output one or more electrical signals capable of controlling the operation of the elevator car driving assembly 204 and the elevator car 206.

The elevator safety and control system 200 further includes a first passenger sensor 208, located within the elevator 206, in electrical communication with the elevator control module 202. Although a single first passenger sensor 208 is shown in the elevator car 206, in some embodiments, multiple first passenger sensors may be utilized within the elevator car 206. The first passenger sensor 208 is arranged to observe an occupancy area of interest 212 defined within the elevator car 206. That is, the occupancy area of interest 212 is a volume within an elevator car where passengers are located during use of the elevator car 206.

In some embodiments, and as shown in FIG. 2, a second passenger sensor 214 can be located at a landing or floor and oriented to monitor a landing area of interest 216. The landing area of interest 216 may be an area at a landing or floor that is proximate to a landing door of the elevator system, e.g., the area where passengers may wait in anticipation to board the elevator car 206. The elevator control module 202 can process the output of the first passenger sensor 208 and/or the second passenger sensor 214 to generate an image and/or extract information regarding the occupancy area of interest 212 and/or the landing area of interest 216. Thus, the system may monitor an interior area of the elevator car 206 and locations at landings and any passengers 210 located in the occupancy area of interest 212 of the elevator car 206 and/or located at the landing area of interest 216 (collectively “areas of interest 212, 216”).

The first and second passenger sensors 208, 214 may be one or more types of sensors to enable capturing information about passengers located in the respective regions of interest. For example, in some non-limiting embodiments, the passenger sensors 208, 214 may be video cameras coupled with a line-of-motion sensing input device, for example, that outputs an electrical signal to the elevator control module 202. In some embodiments, the passenger sensors 208, 214 can be proximity and/or other motion or presence detection sensors. In some embodiments, thermal and/or auditory sensors may be employed. Further, in some embodiments, non-contact, passenger health status sensors may be employed. Such non-contact, passenger health status sensors may be arranged to detect breathing, heart rate, body temperature, etc. of one or more passengers located in the areas of interest 212, 216.

According to an example embodiment, the elevator control module 202 receives output from the first passenger sensor 208 and/or the second passenger sensor 214, and generates an image such as a three dimensional (3-D) image, for example, which can be tracked. Tracking by the systems can include the elevator control module 202 being programmed to interpret specific gestures, movements, and motions of the passengers 210. In addition, the elevator control module 202 can interpret the motion of a first passenger's body parts (e.g., hands, arms, legs, etc.) with respect to a particular region of the areas of interest 212, 216 and/or the body parts of other passengers located within the areas of interest 212, 216 (e.g., relative movement/motion). The 3-D imaging and tracking can further include analysis of health states of the passengers 210 (e.g., heart rate, breathing, etc.).

In a non-limiting example of the passenger sensors 208, 214, the sensors may include infrared laser projectors combined with a monochrome CMOS sensor, which captures video data in 3-D under any ambient light conditions. The sensors may be configured to adjust a sensing range of and automatically calibrate the sensor based on a passenger's physical environment. The elevator control module 202 can monitor and process the outputs from the sensors to determine the presence of an emergency situation associated with a passenger. Emergency situations associated with passengers can include, but are not limited to, lack of movement, increased heart rates, sudden changes in heart rate (including stopping), predetermined/preprogrammed movements or relative movements, etc.

In the event of a detected emergency, the elevator control module 202 can prompt an emergency response. The emergency response can include, for example, generating a vocal alert in the areas of interest 212, 216, notifying emergency personnel or services, activating an alarm, etc. In some embodiments, the notification of emergency personnel or services can include making an automated phone call or electronic request to emergency services.

In addition to monitoring passengers with the passenger sensors 208, 214, the elevator control module 202, in accordance with embodiments of the present disclosure, may also monitor an operational state of the elevator car 206 through connection with one or more operational state elements 218. The operational state elements 218 can include various elevator system components that are typically used for monitoring a state of operation and/or detecting emergency situations and/or reacting to emergency situations. For example, the elevator control module 202 may be connected to one or more operational state elements 218, including, but not limited to safety elements of the elevator system, such as safety gears, emergency brakes, motion/movement sensors (e.g., acceleration/deceleration), safety chains, etc. If an elevator emergency operation is performed, the elevator control module 202 can trigger an emergency response. For example, if a safety gear actuation is detected and passengers are detected within the elevator car 206, the elevator control module 202 can perform an emergency response, such as automatically calling emergency services.

In the elevator safety and control system 200, the elevator control module 202 and associated first passenger sensor 208 are configured to perform a detection process such that if an elevator operational state enters an emergency operation (e.g., safety gear actuation, drop of emergency brake, etc.) the first passenger sensor 208 is used to detect if any passengers are present within the occupancy area of interest 212.

Although shown and described with respect to FIG. 2 with the elevator safety and control system 200 having the second passenger sensor 214 arranged to observe a location on a landing, those of skill in the art will appreciate that elevator safety and control systems of the present disclosure are not so limited. For example, in some embodiments, no sensors will be located at the landings, but rather, the elevator safety and control system may include only a sensor(s) to observe the occupancy area of interest of the elevator car, as monitoring persons at landings may not be necessary, particularly with respect to an emergency event of an elevator car within an elevator shaft.

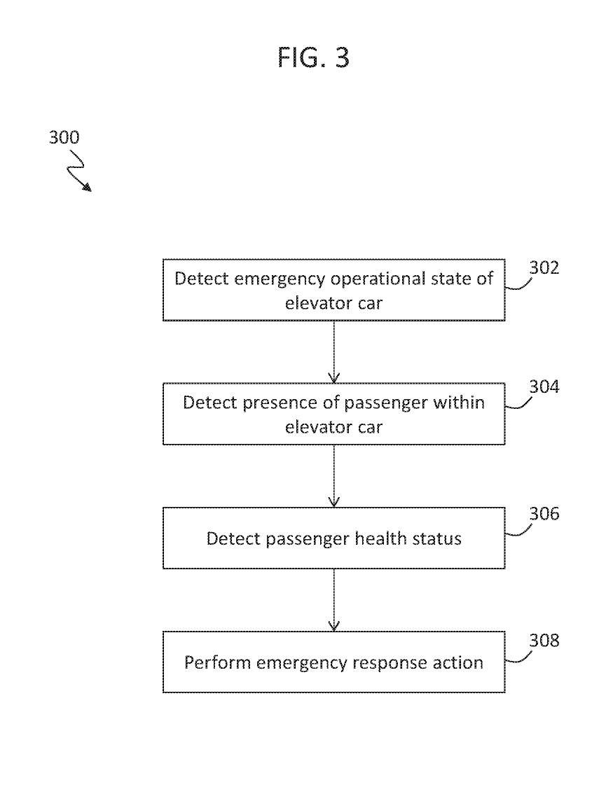

Turning now to FIG. 3, a flow process 300 for performing an emergency action in accordance with an embodiment of the present disclosure is shown. The flow process 300 may be performed by an elevator safety and control system, the system having an elevator control module and one or more passenger detection sensors as shown and described above. The elevator safety and control system further includes monitoring and/or communication with one or more operational state elements that are arranged to monitor and/or control an operational state of an elevator car within an elevator shaft.

At block 302, the elevator safety and control system detects an emergency state of operation or emergency event of the elevator system. For example, such detection may include operation of a safety gear, dropping of an emergency brake, breaking of a safety chain, dramatic changes in acceleration or deceleration, or other operational states of an elevator car that are outside of typical operational parameters. When such event occurs, passengers within an elevator car may be injured or such event may occur due to an injury or other health state of a passenger within the elevator car.

At block 304, upon determination that an emergency state of operation or emergency event has occurred, the elevator safety and control system determines if any passengers are located within an occupancy area of interest of an elevator car. That is, a passenger sensor is used to detect if any passengers are located within an elevator car.

At block 306, upon determination that a passenger is located within the elevator car that was subject to the emergency state of operation or emergency event, the elevator safety and control system determines a health status of the passenger (or passengers). Such health status may be as passive as a motion or position detection (e.g., 3-D imaging) to determine if a passenger has collapsed or has otherwise be moved into a position that is unexpected (as compared to known or learned “normal” states).

The health status detection performed at block 306 can include a timer associated with a passenger initiated action. For example, in some embodiments, once it is determined that there is a passenger within the elevator car, and an emergency event has occurred, a time may begin. If a predetermined amount of time elapses without activation of an emergency call button, then the flow process may proceed to block 308. That is, as will be appreciated by those of skill in the art, elevators are typically equipped with emergency call buttons that can be operated by passengers within the elevator car. When the emergency call button is not activated within the time period, the flow process 300 proceeds to block 308. In other embodiments, if there is no movement detected within the elevator car within a predetermined time, the flow process 300 will proceed to block 308.

At block 308, based on a detection of a health status of one or more passengers and/or an elapsed time, the elevator safety and control system can perform an emergency response action. The emergency response action can include notification of emergency personnel or services such as making an automated phone call or electronic request to emergency services. Other emergency response actions can include alerting security/emergency personnel, cancelling an elevator call in order not to put passengers in an enclosed/unmonitored space for their safety and the safety of passengers standing by, generating an acoustic alert to notify the passenger(s) of a security issue, and/or automatically overriding current elevator operations.

In one non-limiting example of an elevator safety and control system in accordance with the present disclosure, a motion detector and an infrared camera (passenger sensors) are installed within an elevator car and are in communication with an elevator control module. The elevator control module is arranged to process imaging and/or data from the passenger sensors to detect the presence of passengers in the occupancy space of the elevator car. If the elevator control module determines that there is a passenger in the elevator car and the elevator is stopped due to an emergency operation, a timer will start and run for a predetermined time period. After expiration of the predetermined time period, if there is no detected movement within the elevator car, the elevator control module can trigger or perform an emergency response action. In one non-limiting example, the predetermined time period may be one or two minutes. One example of an emergency response action may be to trigger or notify an operator to call the passengers of the elevator car directly to see if there is a problem. If no one responds, the operator may then request an intervention or emergency team to be sent to the scene.

In another example, such as one without a timer, if an emergency operation or state is detected by an elevator safety and control system and passengers are detected within the elevator car, the elevator safety and control system may automatically perform an emergency response action. That is, in one example, if a safety gear of the elevator system is actuated, and passengers are detected within the elevator car, the elevator safety and control system may automatically contact emergency personnel or services to respond to the scene.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator safety and control system comprising:
an elevator car moveable within an elevator shaft;
at least one operational state element associated with movement of the elevator car within the elevator shaft;
a passenger sensor positioned within the elevator car and configured to monitor an occupancy area of interest inside the elevator car and to observe at least one passenger located in the occupancy area of interest; and
an elevator control module in communication with the passenger sensor and the at least one operational state element, the elevator control module configured to:
determine an emergency state of operation of the elevator car;
determine a presence of at least one passenger within elevator car; and
perform emergency response action.

2. The elevator safety and control system of claim 1, wherein the at least one operational state element is one or more of a safety gear, an emergency brake, an acceleration/deceleration sensor, and a safety chain.

3. The elevator safety and control system of claim 1, wherein the passenger sensor is a motion tracking sensor.

4. The elevator safety and control system of claim 1, wherein the elevator control module is further configured to initiate a timer at the time of determining an emergency state of operation and the presence of the at least one passenger within the elevator car.

5. The elevator safety and control system of claim 4, wherein, upon expiration of the timer, the emergency response action is performed.

6. The elevator safety and control system of claim 1, wherein the emergency response action is at least one of notification of emergency personnel or services, making an automated phone call or electronic request to emergency services, alerting security/emergency personnel, cancelling an elevator call, generating an acoustic alert, or overriding a current elevator operational state.

7. A method for performing elevator safety and control, the method comprising:
determining, with an elevator control module, an emergency state of operation of an elevator car within an elevator shaft;
determining a presence of at least one passenger within the elevator car; and
performing an emergency response action upon determination of the emergency state of operation and the presence of the at least one passenger within the elevator car.

8. The method of claim 7, wherein the elevator control module is in communication with at least one operational state element associated with movement of the elevator car within the elevator shaft, the method further comprising:
receiving operational state information at the elevator control module from the at least one operational state element.

9. The method of claim 8, wherein the at least one operational state element is one or more of a safety gear, an emergency brake, an acceleration/deceleration sensor, and a safety chain.

10. The method of any of claim 7, wherein the elevator control module is in communication with a passenger sensor positioned within the elevator car and configured to monitor an occupancy area of interest inside the elevator car and to observe at least one passenger located in the occupancy area of interest, the method further comprising:
receiving information associated with a detected passenger at the elevator control module from the passenger sensor.

11. The method of any of claim 7, wherein the emergency response action is at least one of notification of emergency personnel or services, making an automated phone call or electronic request to emergency services, alerting security/emergency personnel, cancelling an elevator call, generating an acoustic alert, or overriding a current elevator operational state.

12. The method of any of claim 7, further comprising initiating a timer at the time of determining an emergency state of operation and the presence of the at least one passenger within the elevator car.

13. The method of claim 12, wherein, upon expiration of the timer, the emergency response action is performed.
